(19) United States
(12) Patent Application Publication
(10) Pub. No.: US 2023/0316109 A1
(43) Pub. Date: Oct. 5, 2023

(54) AUTOMATIC CONSTRUCTION OF FAULT-FINDING TREES

(71) Applicant: KONINKLIJKE PHILIPS N.V., EINDHOVEN (NL)

(72) Inventors: Johannes Henricus Maria KORST, EINDHOVEN (NL); Mauro BARBIERI, EINDHOVEN (NL); Serverius Petrus Paulus PRONK, VUGHT (NL); Marc André PETERS, VELDHOVEN (NL); Qi GAO, EINDHOVEN (NL)

(21) Appl. No.: 18/020,094

(22) PCT Filed: Aug. 6, 2021
(86) PCT No.: PCT/EP2021/072061

§ 371 Date: Feb. 7, 2023

Related U.S. Application Data
(60) Provisional application No. 63/064,036, filed on Aug. 11, 2020.

(51) Int. Cl. G06N 5/04; G06N 7/01

(52) U.S. Cl. CPC G06N 5/04; G06N 7/01

(57) ABSTRACT

A non-transitory computer readable medium (107, 127) stores instructions executable by at least one electronic processor (101, 113) to perform a method (200, 300) of generating a recommendation engine for recommending actions during performance of a fault-finding task. The method comprises: converting a collection of historical fault-finding process sequences (140) into a fault-finding tree (130) having nodes (132), action edges (135) and outcome edges (137) connecting the nodes. The action edges are labeled with actions of the historical fault-finding process sequences and the outcome edges are labeled with outcomes of the historical fault-finding process sequences. The nodes include terminal nodes (133) labeled with root causes or solutions identified by the historical fault-finding process sequences. A visualization (142) of the fault-finding tree is provided on a user interface (UI) (120) on a service device (102) operable by a field service engineer (FSE).

### FIELD

The following relates generally to the medical device maintenance arts, fault-finding tree construction arts, fault-finding tree visualization arts, fault-finding tree navigational arts, and related arts.

### BACKGROUND

Maintenance of medical imaging systems typically consists of three types of maintenance actions. Planned maintenance, which includes periodically calibrating, lubricating, cleaning, and so forth, components of a system. In addition, preventive maintenance includes continuously monitoring the condition of the system so that some of the parts or components can be replaced preventively before they actual break. In addition, reactive maintenance includes, in reaction to the call of a customer (i.e., a hospital) or in reaction to the observation of some error by a condition monitoring system, resolving the issue as soon as possible. Planned and preventive maintenance generally require only planned downtime of the system, typically at a time that is convenient to the customer. However, reactive maintenance generally involves unplanned downtime of the machine, which may involve considerable costs and the rescheduling of patients.

For reactive maintenance cases, it is desirable to resolve the issue as soon as possible, as the imaging device may be down or operating at reduced capability. However, determining the root cause of a system failure may not be easy. Medical imaging systems are complicated machines, and quickly resolving the issue can be difficult sometimes, as there can be a diversity of relatively rare root causes. A medical imaging system contains many parts and each of these parts may have multiple failure modes. Ideally, the root cause of an imaging system failure can be determined remotely based on the log data that the machine produced just before the failure. However, this is not always possible, and in those cases, a field service engineer (FSE, also referred to herein as service engineer, or other variants thereof) has to visit the hospital as soon as possible to perform various actions (e.g. tests, component inspections, or so forth) to identify the root cause and possibly order the parts that are required to resolve the issue. Determining the root cause can be a stressing activity, as the hospital would typically like to get the problem solved as quickly as possible, given that the system is not (fully) functional in these situations.

The following discloses certain improvements to overcome these problems and others.

### SUMMARY

In one aspect, a non-transitory computer readable medium stores a fault finding tree comprising nodes and edges. The nodes include terminal nodes labeled with root causes or solutions and occurrence rates for the root causes or solutions and the edges include action edges labeled with actions and time-to-complete values for the actions. Instructions are readable and executable by at least one electronic processor to perform an iterative method for recommending actions for a fault-finding task using the fault finding tree. An iteration of the iterative method has an associated set of reachable action edges and reachable terminal nodes, and comprises: computing expected times to resolve the fault-finding task for different sequences of the reachable action edges using the time-to-complete values of actions associated with the reachable action edges and the occurrence rates for the reachable terminal nodes; determining at least one recommended next action from the actions labeled to the reachable action edges based on the computed expected times; displaying the at least one recommended next action; receiving an outcome observation for an action performed by a user; and determining a set of reachable action edges and reachable terminal nodes for a next iteration of the iterative method based on the received outcome observation.

In another aspect, a non-transitory computer readable medium stores instructions executable by at least one electronic processor to perform a method of generating a recommendation engine for recommending actions during performance of a fault-finding task. The method comprises: converting a collection of historical fault-finding process sequences into a fault-finding tree having nodes, action edges and outcome edges connecting the nodes. The action edges are labeled with actions of the historical fault-finding process sequences and the outcome edges are labeled with outcomes of the historical fault-finding process sequences. The nodes include terminal nodes labeled with root causes or solutions identified by the historical fault-finding process sequences. A visualization of the fault-finding tree is provided on a user interface (UI) on a service device operable by a field service engineer (FSE).

In another aspect, a service device includes: a display device; at least one user input device; and at least one electronic processor. A non-transitory storage medium stores instructions readable and executable by the at least one electronic processor to perform an iterative method for recommending actions for a fault-finding task using a fault finding tree wherein an iteration of the iterative method has an associated set of reachable action edges and reachable terminal nodes and comprises: computing expected times to resolve the fault-finding task for different sequences of the reachable action edges using the time-to-complete values of actions associated with the reachable action edges and the occurrence rates for the reachable terminal nodes; determining at least one recommended next action from the actions labeled to the reachable action edges based on the computed expected times; displaying the at least one recommended next action; receiving an outcome observation for an action performed by a user; and determining a set of reachable action edges and reachable terminal nodes for a next iteration of the iterative method based on the received outcome observation.

One advantage resides in providing an improved fault-finding tree that provides expected times to reach root cause for various branches that are updated as the user progresses through the tree.

Another advantage resides in automatically generating a fault-finding tree with recommended actions.

Another advantage resides in automatically generating a fault-finding tree with historical cases from an FSE.

Another advantage resides in iteratively updating a fault-finding tree with inputs indicative of an outcome observation for an action recommended by the fault-finding tree.

Another advantage resides in providing a fault-finding tree to more accurately identify a root cause of a problem with a system or device.

Another advantage resides in providing a device for assisting an FSE in diagnosing a problem with a medical imaging device, which uses a fault-finding tree to provide guidance to the FSE in efficiently selecting actions.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the disclosure.

FIG. 1 diagrammatically illustrates an illustrative system for optimizing a service plan for a medical system in accordance with the present disclosure.

FIG. 2 shows an example of a fault-finding tree implemented by the system of FIG. 1.

FIG. 3 shows exemplary flow chart operations of the system of FIG. 1.

FIGS. 4-9 show examples of generating the fault-finding tree of FIG. 2.

### DETAILED DESCRIPTION

The following relates to an approach for providing an automated fault-finding tree for use by a FSE or other person engaged in diagnosis of a complex system. The disclosed systems and methods efficiently and automatically construct a compact fault-finding tree from a set of historical fault-finding sequences, for example performed by FSEs in the past, along with efficient ways to adapt and use the fault-finding tree in specific fault-finding tasks.

To aid a FSE during downtime of an imaging system, it is disclosed herein to use a fault-finding tree to assist in the diagnostic process. A fault-finding tree can be seen as a directed rooted tree where each edge in the tree corresponds to either performing a service action or to observing an outcome where depending on the outcomes of a service action some root causes can be discarded as they can no longer be reached from the root node. Each node is associated to at most one root cause, and each root cause is associated to one or more nodes. At the start of the root cause analysis process, one starts at the root node of the fault-finding tree. At each step of the root cause analysis process, one is at one or more nodes in the tree, called the set of current nodes. The set of current nodes is defined as the set of nodes that can be reached from the root node by only using the edges that are labelled with the service actions that have already been executed as well as the edges that are labelled with the subsequent observed outcomes. Depending on the already identified symptoms and the outcomes of already performed service actions, the fault-finding tree gives the set of service actions that can be performed next as edges starting at one of the current nodes, with associated probabilities of success and associated times.

In this way, the FSE is guided to resolve the issue as quickly as possible. Once a node is reached that has an associated root cause, the case is considered resolved. A check to determine whether the initial problem is actually solved is part of the fault-finding tree, such that a node with associated root cause is only reached whenever this check is already performed and the outcome of the test confirms that this actually resolved the issue. Furthermore, the actual root cause may not be known, but the solution that resolved the issue is known. For example, the solution is the replacement of a given part p, while it is not known exactly which of the failure modes of the given part caused the problem. In those cases, the solution is simply considered as a proxy for root cause and multiple root causes that are resolved by the same solution are combined to the same root node proxy.

The disclosed automated fault-finding tree is suitably used in combination with an electronic user interface (UI) running on a computer, mobile device, or the like employed by the FSE. The UI preferably automatically records the fault-finding sequence performed by the FSE. For example, the UI may provide drop-down lists or other selection lists from which the user selects an action to perform and records the outcome of the action. This allows for automated generation of historical fault-finding sequences for use in constructing or updating the fault-finding tree. Additionally or alternatively, natural language processing (NLP) may be performed on typed or spoken/recorded description of the fault-finding sequence provided by the FSE to extract the sequence of actions/outcomes. In a variant embodiment, the set of sequences for constructing the tree may be manually extracted from service logs by a domain expert.

Given a set of fault-finding sequences, an iterative process is performed to construct the fault-finding tree. To this end, the tree has a specified structure in which each node is either an action node or an outcome node. Each action node has edges corresponding only to actions descending from it, while each outcome node has only edges corresponding to outcomes descending from it. Furthermore, each action edge is labeled by a time-to-complete. Leaf nodes are formally designated as action nodes although no actions extend from a leaf node. Some (but not necessarily all) leaf nodes are labeled with a root cause or solution. Some action nodes may connect with lower action nodes, so as to model a sequence of two (or more) actions that are performed to obtain an outcome.

Briefly, the process iteratively adds each sequence of the set of sequences in turn. This entails adding any new nodes/branches for the sequence that are not already in the tree, adjusting the time-to-complete for each action edge already in the tree (e.g. by averaging the time-to-complete over all sequences having that action edge), and incrementing the count of the leaf node representing the root cause or solution reached by the fault-finding sequence being added. Advantageously, this iterative addition of successive historical fault-finding sequences to the fault-finding tree enables the tree to be updated over time as more historical fault-finding sequences are obtained via fault-finding tasks routinely carried out by FSEs.

The constructed fault-finding tree serves as an action recommendation component for the UI employed by the FSE. The disclosed systems and methods compute the expected time to reach a root cause based on the time-to-complete labels of the action edges and the probabilities of the root causes or solutions represented by the leaf nodes. The approach is dynamic in at least two ways. First, the time-to-complete labels can be adjusted in real-time based on the specifics of the current fault-finding process. For example, if the FSE wants to perform an action that involves replacing a part, but the FSE does not have the part at-hand, then the FSE uses the UI to order the part, and the UI returns an expected delivery time. This expected delivery time then can be used to update the time-to-complete (e.g., if it is in stock then delivery time may be only an hour; whereas if the part needs to be ordered then the delivery time may be two days). Second, as the FSE navigates through the fault-finding tree by performing actions and recording outcomes, some branches and corresponding root causes/solutions become unreachable. At any given time, the probability of a given root cause or solution is the count of occurrences of that root cause/solution in the sequences used to construct the tree divided by the total count of occurrences of all root causes/solutions that are still reachable in the tree.

In addition, a graphical representation of the fault-finding tree is optionally presented. In some embodiments (e.g., suitably used by a domain expert), the entire tree is displayed (or a portion is displayed at a given time and the user can pan about to see the whole tree). This view shows the default time-to-complete values for action edges, and the raw counts for root causes/solutions. This display is useful for a domain expert who can trim the tree based on expert knowledge, for example by removing node dependencies that the expert knows are actually unrelated, and/or adjusting time-to-complete values for action edges and/or counts for root causes/solutions based on his/her expert knowledge.

In other embodiments (e.g., suitably used by an FSE), the display shows only the portion of the fault-finding tree that is still reachable at any given time during the fault-finding process being performed by the FSE. This visualization shows the time-to-complete values for action edges as dynamically adjusted for the current fault-finding process, and shows the normalized probabilities for the remaining reachable root causes/solutions, again as dynamically adjusted for the current fault-finding process.

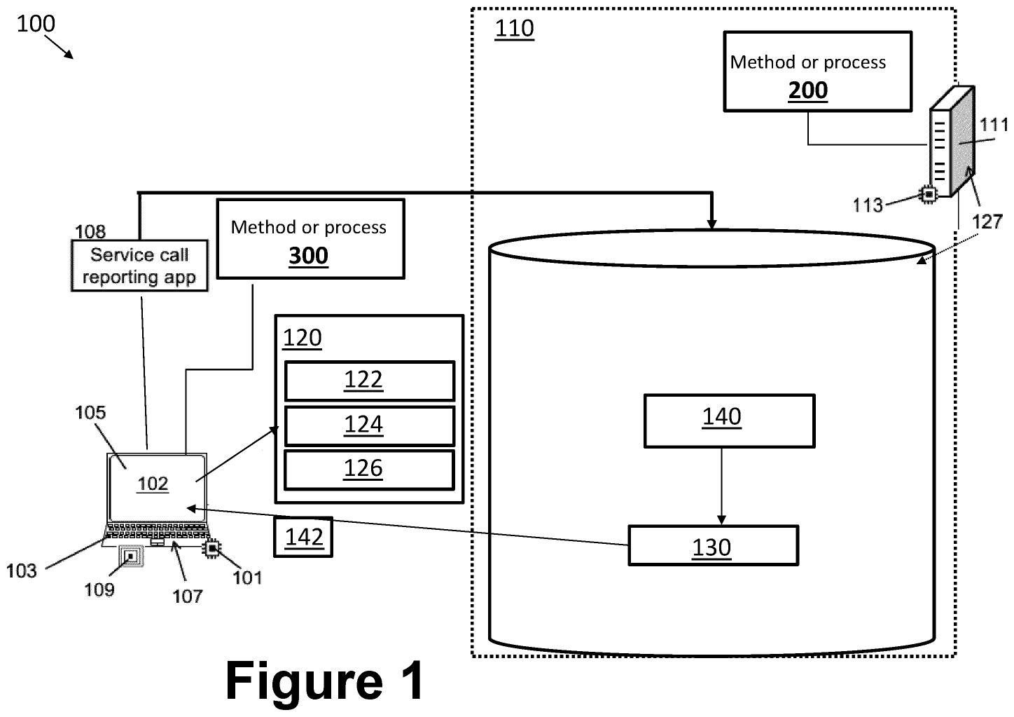

With reference to FIG. 1, an illustrative servicing support system 100 for supporting a service engineer in servicing a device (e.g., a medical imaging device, not shown—also referred to as a medical device, an imaging device, imaging scanner, and variants thereof) is diagrammatically shown. By way of some non-limiting illustrative examples, the medical imaging device under service may be a magnetic resonance imaging (MRI) scanner, a computed tomography (CT) scanner, a positron emission tomography (PET) scanner, a gamma camera for performing single photon emission computed tomography (SPECT), an interventional radiology (IR) device, or so forth. As shown in FIG. 1, the servicing support system 100 includes, or is accessible by, a service device 102 carried or accessed by a FSE. The service device 102 can be a personal device, such as a mobile computer system such as a laptop or smart device. In other embodiments, the service device 102 may be an imaging system controller or computer integral with or operatively connected with the imaging device undergoing service (e.g., at a medical facility). As another example, the service device 102 may be a portable computer (e.g. notebook computer, tablet computer, or so forth) carried by a FSE performing diagnosis of a fault with the imaging device and ordering of parts. In another example, the service device 102 may be the controller computer of the imaging device under service, or a computer based at the hospital. In other embodiments, the service device may be a mobile device such as a cellular telephone (cellphone) or tablet computer and the servicing support system 100 may be embodied as an “app” (application program). The service device 102 allows the service engineer to interact with the servicing support system via at least one user input device 103 such a mouse, keyboard, or touchscreen. The service device further includes an electronic processer 101 and non-transitory storage medium 107 (internal components which are diagrammatically indicated in FIG. 1). The non-transitory storage medium 107 stores instructions which are readable and executable by the electronic processor 101 to implement the servicing support system 100. The service device 102 may also include a communication interface 109 such that the servicing support system 100 may communicate with a backend server or processing device 111, which may optionally implement some aspects of the servicing support system 100 (e.g., the server 111 may have greater processing power and therefore be preferable for implementing computationally complex aspects of the servicing support system 100). Such communication interfaces 109 include, for example, a wireless Wi-Fi or 4G/5G interface, a wired Ethernet interface, or the like for connection to the Internet and/or an intranet. Some aspects of the servicing support system 100 may also be implemented by cloud processing or other remote processing.

In illustrative FIG. 1, the servicing information collected using a service call reporting app 108 is fed to a database backend 110 (e.g., implemented at a medical facility or other remote center from where the FSE is performing the service call, or at the imaging device vendor or other servicing contractor). For example, the database backend 110 may implement a service log for the medical imaging device. The backend processing is performed on the backend server 111 equipped with an electronic processor 113 (diagrammatically indicated internal component). The server 111 is equipped with non-transitory storage medium 127 (internal components which are diagrammatically indicated in FIG. 1). While a single server computer is shown, it will be appreciated that the backend 110 may more generally be implemented on a single server computer, or a server cluster, or a cloud computing resource comprising ad hoc-interconnected server computers, or so forth. Furthermore, while FIG. 1 shows a single service device 102, more generally the database backend 110 will receive service call reports from many service devices (e.g., tens, hundreds, or more service devices) carried by different FSEs, and each FSE will be providing a service call report for each service call that the FSE makes (this may total hundreds or even a few thousand service calls per year by a given FSE). Hence, over time the database backend 110 accumulates a large quantity of service call reporting data.

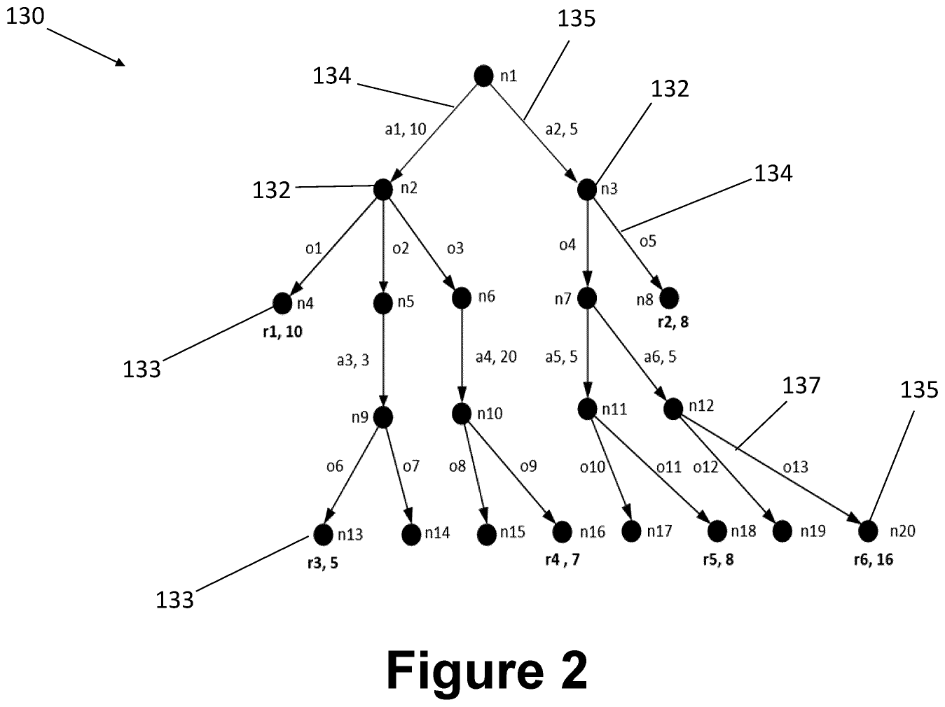

With reference to FIG. 2, and with continuing reference to FIG. 1, the non-transitory computer readable medium 127 stores a fault-finding tree 130. As shown in FIG. 2 which presents a rendering of the fault-finding tree 130, the fault-finding tree 130 includes nodes 132 (depicted as circles) and edges 134 (depicted as arrows) connecting the nodes. In some examples, the nodes 132 include terminal nodes 133 labeled with root causes or solutions (e.g., solutions for malfunctions of a medical imaging device) and occurrence rates for the root causes or solutions (e.g., a number of actually-performed fault finding sequences that ended in that particular root cause) of historical fault-finding process sequences. These occurrence rates may or may not be normalized. In addition, some terminal nodes may not include such labels (i.e., “dead” nodes terminating paths that do not lead to identifying a root cause or solution). In other examples, the edges 134 include action edges 135 labeled with actions (i.e., service actions for a medical imaging device) and time-to-complete values for the actions. In addition, the edges 134 can include outcome edges 137 labeled with outcomes of the historical fault-finding process sequences.

The non-transitory storage medium 127 stores instructions executable by the electronic processor 113 of the backend server 111 to perform a method 200 of generating a recommendation engine (i.e., the fault-finding tree 130) for recommending actions during performance of a fault-finding task (e.g., by the FSE).

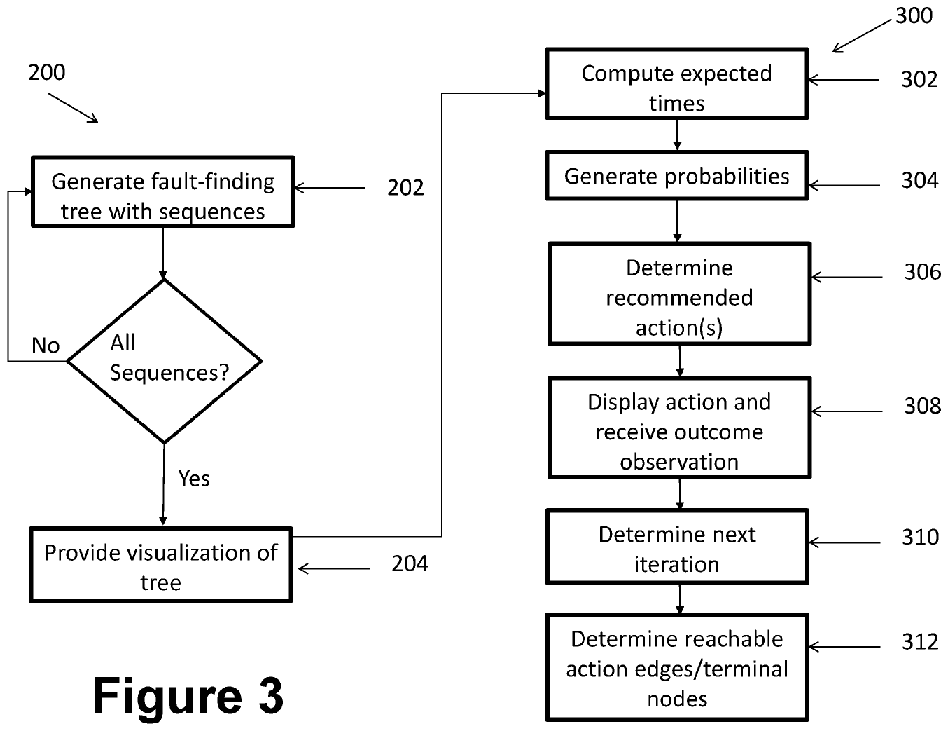

With reference to FIG. 3, and with continuing reference to FIGS. 1 and 2, an illustrative embodiment of an instance of the device service support method 200 executable by the electronic processor 113 is diagrammatically shown as a flowchart. In some examples, the method 200 may be performed at least in part by cloud processing. The method 200 result in an output of the generated fault finding tree 130, which can then be displayed on the display device 105 of the service device 102.

At an operation 202, a collection of historical fault-finding process sequences 140 (which can be stored in the non-transitory storage medium 127) are converted into the fault-finding tree 130 having the nodes 132 and the edges 134. The converting operation 202 is performed by adding increasingly longer prefixes of a set of available fault-finding sequences are used to iteratively construct the fault-finding tree 130. In some examples, the historical fault-finding sequences 140 are historical fault-finding sequences performed by FSEs servicing medical imaging devices.

Each historical fault-finding sequence 140 is added to the fault-finding tree 130 in the following manner. An action edge 135 labeled with the action is added to the fault-finding tree 130 for each action of the historical fault-finding sequence that is not in the fault-finding tree. An outcome edge 137 labeled with the outcome is added to the fault-finding tree 130 for each outcome of the historical fault-finding sequence that is not in the fault-finding tree. One of two options occur for handling the root cause or solution identified by the historical fault-finding sequence. In one option, if the fault-finding tree 130 does not include a terminal node 133 labeled with the root cause or solution identified by the historical fault-finding process sequence, then a terminal node labeled with the root cause or solution identified by the historical fault-finding process sequence is added to the fault-finding tree, and the added terminal node is labeled with an occurrence rate of 1. In the other option, if the fault-finding tree 130 does include a terminal node 133 labeled with the root cause or solution identified by the historical fault-finding process sequence, then the occurrence rate of the terminal node labeled with the root cause or solution identified by the historical fault-finding process sequence is incremented.

To complete the operation 202, the non-transitory computer readable medium 127 of the backend server 111 further stores machine learning (ML) instructions readable and executable by the at least one electronic processor 113 to generate the fault-finding tree 130 by iteratively updating the fault-finding tree with each historical fault-finding sequence of a collection of historical fault-finding sequences. The fault-finding tree 130 is iteratively updated with each sequence in the collection of sequences. To do so, additional nodes 132 or branches for a sequence not already in the fault-finding tree 130 are added thereto.

At an operation 204, a visualization 142 of the fault-finding tree 130 is provided on a graphical user interface (GUI) 120 on the service device 102. In some examples, the providing operation 204 includes displaying, on the GUI 120, an entirety of the fault-finding tree 130 as the visualization showing default expected time-to-complete labels for the action edges 135 and raw counts for the root causes. In other examples, the providing operation 204 includes displaying, on the GUI 120, a portion of the fault-finding tree 130 showing only root causes with probabilities reachable as a possible root cause of the fault-finding process.

Once the visualization 142 of the fault-finding tree 130 is provided on the service device 102, the FSE can then interact with the visualization via the at least one user input device 103. The non-transitory storage medium 107 stores instructions executable by the electronic processor 101 of the service device 102 to perform an iterative method 300 for recommending actions for a fault-finding task (e.g., by the FSE) using the fault finding tree 130.

With continuing reference to FIGS. 1-3, an illustrative embodiment of an instance of action recommendation method 300 executable by the electronic processor 101 is diagrammatically shown as a flowchart in FIG. 3.

An iteration of the iterative method 300 has an associated set of reachable action edges 135 and reachable terminal nodes 133, and includes operations 302-310. At an operation 302, expected times to resolve the fault-finding task are computed for different sequences of the reachable action edges using the time-to-complete values of actions associated with the reachable action edges 135 and the occurrence rates for the reachable terminal nodes 133. In some examples, this computing operation 302 can include receiving information from the FSE (via the at least one user input device 103) relating to a reachable action edge 135. The corresponding time-to-complete value labeling the reachable action edge 135 is updated based on the received information. The updated time-to-complete value is used to re-compute the expectation times for the fault-finding task.

At an optional operation 304, the occurrence rates of the root causes or solutions of the reachable terminal nodes 133 are normalized to generate probabilities of the root causes or solutions of the reachable terminal nodes. For example, if there are Nᵣ reachable root causes or solutions then the values Rᵢ, i=1, . . . , Nᵣ are normalized as R_{i,norm}=Rᵢ/(R₁+R₂+ . . . +R_{Nr}) which ensures that R_{1,norm}+R_{2,norm}+ . . . +R_{Nr,norm}=1.

At an operation 306, at least one recommended next action is determined from the actions labeled to the reachable action edges 135 based on the computed expected times.

At an operation 308, the at least one recommended action is displayed on the display device 105, and an outcome observation for the at least one recommended action is received. In some examples, when more than one recommendation action is determined at the operation 304, then the recommended actions are displayed as a ranked list on the display device 105. To perform the displaying operation 306, the non-transitory computer readable medium 107 further stores user interfacing instructions readable and executable by the at least one electronic processor 101 to provide, on the GUI 120, a log entry user interface 122 for logging medical imaging device servicing, a parts ordering user interface 124 for ordering parts for medical imaging devices, and a recommender user interface 126 via which the iteration of the iterative method 300 displays the at least one recommended next action and receives the outcome observation for the action performed by a user.

The outcome observation can be an input from the FSE via the at least one user input device 103, such as a mouse click, dictation instructions, or keystrokes. In cases of keystrokes, a NLP process can be performed on the text entered by the FSE. In other examples, the outcome observation can be extracted from a service log of an associated medical imaging device.

At an operation 312, a set of reachable action edges and reachable terminal nodes for a next iteration of the iterative method is determined based on the received outcome observation. The operations 302-310 are then repeated for each recommended action.

It should be noted that the iterative method 300 for providing action recommendations to an FSE can optionally be performed without performing the operation 204 of providing the visualization of the fault-finding tree. In such an approach, the FSE would see the recommendations via the operation 308, but would not see a visualization of the fault-finding tree. Conversely, in the case of a support engineer, for example accessing the fault-finding tree 130 at a backend workstation, such a support engineer would be presented with a visualization of the tree as per operation 204, but would typically not utilize the iterative method 300. In this latter case of a support engineer accessing the fault-finding tree 130 at a backend workstation, the operation 204 may be augmented by a user interface having tree-editing capabilities, for example allowing the support engineer to trim nodes and/or edges from the fault-finding tree 130.

### Example

The following describes the methods 200, 300 in more detail. The methods 200, 300 use information from historical service cases to construct a fault-finding tree 130. Each historical service case has a sequence of service actions (such as performing checks) and corresponding outcomes (observing the result of the checks) that have been carried out or observed to resolve the issue, and the corresponding root cause. In some cases, the actual root cause may not be known but only the solution that resolved the issue. In that case, the solution is used as a proxy for the actual root cause.

As noted, an example of the fault-finding tree 130 is shown in FIG. 2. A given set of sequences of service actions and outcomes are used to construct the rooted directed fault-finding tree 130 T=(N, E), consisting of nodes 132 and directed edges 134. An edge e∈E is labelled with either a performed service action or an observed outcome, resulting in a partitioning of E into two subsets Eₐ and Eₒ relating to service actions and outcomes, respectively. The edges are called service action edges and outcome edges, respectively. All edges starting at a node n∈N, are either all in Eₐ or all in Eₒ. A node where service actions start is called a service action node, and a node where outcome edges start is called an outcome node. Hence, N=Nₐ∪Nₒ, with Nₐ∩Nₒ=Ø. By definition, the root node is a service action node and leaf nodes are also considered service action nodes. A service action node n∈Nₐ can be labelled with a root cause (or solution proxy) and a corresponding count c(n) specifying the number of historical sequences that match with finding this root cause with such a sequence at this node. Such a node is called a root cause node. An outcome node cannot be a root cause node. In addition, a service action edge e∈Eₐ that is labelled with a service action aᵢ is additionally labelled with d(aᵢ), the duration of this service action. Observing an outcome is assumed to have a duration equal to zero. In the following explanation, this assumption is made. But it can easily be shown that outcome edges can also be given non-zero durations.

The duration d(aᵢ) can be chosen to be the mean or median duration of all occurrences of service action aᵢ that appear in the historical cases. The outcome edges that start at the same outcome node are assumed to be mutually exclusive. After the execution of the preceding service action, one of these outcomes is observed, while disabling the other outcomes, making the associated subtrees and root cause nodes therein no longer reachable.

A path of the root node to another node in the fault-finding tree 130 need not necessarily strictly alternate between a service action edge and an outcome edge. It is possible that two service actions a and a′ are performed one after the other, without observing an outcome in between the execution of a and the subsequent execution of a′. It can be that service action a is simply a necessary step to be able to execute service action a′ and one or more other service actions. If a is a necessary step for only a′, then a and a′ could be combined to one composite service action, but if a is a necessary step to be able to execute multiple other service actions (a′, a″, . . . ), then it makes sense to define a as a separate service action that need not result in any outcome, having a duration d(a) that has to be executed only once.

In FIG. 2, the fault-finding tree 130 includes a set of 20 nodes N={n₁, n₂, . . . , n₂₀} and a set of 19 edges that are labelled with either a service action from the set {a₁, . . . , a₆} or labelled with an outcome from the set {o₁, . . . , o₁₃}. The set of service action nodes Nₐ is given by Nₐ={n₁, n₄, . . . n₈, n₁₃, . . . , n₂₀} of which {n₄, n₈, n₁₃, n₁₆, n₁₈, n₂₀} have an associated root causes. For example, node n₄ has root cause r₁ and an associated count of 10. The set of outcome nodes Nₒ is given by Nₒ={n₂, n₃, n₉, . . . , n₁₂}. All edges starting at an outcome node are outcome edges and no outcome edges start at a service action node. Root causes are associated to only one node in this example. In general, a root cause can be associated to one or more nodes.

The fault-finding tree 130 can be used to find the root cause as follows. The assumption is that there is exactly one root cause rᵢ that can be reached by a path from the root node to the node that is labelled with rᵢ. Each step in the process of finding the root cause of a specific case can be modelled as a subset of reached service action nodes Nᵣ⊆Nₐ, where initially Nᵣ only contains the root node of the fault-finding tree 130. Each step in the process consists of selecting a service action edge e=(n, n′) for which n has already been reached, i.e., n∈Nᵣ. Let aⱼ denote the corresponding service action. Then executing this service action is assumed to require d(aᵢ) time units. If n′ is a service action node then n′ is added to Nᵣ. If n′ is an outcome node, then an outcome that relates to exactly one of the outcome edges starting at node n′ is observed, which is assumed not to require additional time. Let e′=(n′, n″) be the outcome edge that relates to the observed outcome, then n″ is added to Nᵣ the set of reached service action nodes. Additionally, the other outcome edges that start at node n′ are disabled, such that the nodes in the corresponding subtrees are no longer reachable. As a consequence, the root causes that only occur in these subtrees are also no longer reachable. If node n′ or n″ that is just added to Nᵣ is labelled with a root cause rₖ, then by the assumption that there is exactly one reachable root cause, root cause rₖ is the unique root cause, and the process terminates.

In the fault-finding tree 130, the set of reached service action nodes is initiated with Nᵣ={n₁}. In this example, there are six possible root causes r₁, r₂, r₃, r₄, r₅ and r₆. The tree is based on 54 historical cases, where r₁ was the root cause in 10 cases, r₂ in 8 cases, r₃ in 5 cases, r₄ in 7 cases, r₅ in 8 cases, and r₆ in 16 cases. Hence, the probabilities of each of these root causes are initially estimated to be given by p(r₁)=10/54, p(r₂)=8/54, p(r₃)=5/54, p(r₄)=7/54, p(r₅)=8/54, and p(r₆)=16/54. Given that initially Nᵣ={n₁}, the output includes service actions a₁ or a₂. Service action a₁ has a duration of 10 time units and may directly lead to root cause r₁, if after a₁, o₁ is observed. The probability to observe o₁ after executing a₁ is estimated to be equal to p(r₁). Conversely, a₂ can be performed which has a duration of only 5 time units leading to root cause r₄, if after a₂, o₉ is observed which has an estimated probability of p(r₂).

As used herein, the expected time-to-completion (or resolution) refers to, given a sequence [symbol] of service actions [symbol] =(a₁, a₂, . . . , aₖ), then the expected time to resolution of sequence [symbol] is the expected time to finding the unique root cause, using the estimated initial probabilities of root causes, given that the service actions are carried out in the given order, where a next service action aᵢ is skipped whenever it is no longer reachable, and the algorithm terminates after the execution of a service action aⱼ that leads to the addition of a root cause node to Nᵣ. The expected time to resolution is generally a weighted sum of the durations of the service actions.

The sequence of service actions that leads to the shortest expected time to resolution can be determined by computing the expected time to resolution for each of the possible orderings of service actions. [symbol] =(a₁, a₂, a₃, a₄, a₅, a₆) represents an ordering of the service actions of the fault-finding tree 130 shown above. For example, if after execution of a₁ o₁ is observed, then the root cause r₁ is found, and the process completes. However, if o₁ is not observed, then o₂ or o₃ is observed. In that case, the next service action is a₂. If o₅ is subsequently observed, then root cause r₂ is found, and the process completes. If o₄ is observed, then the process continues with either a₃ or a₄, whichever one is still possible given the observation o₂ or o₃. The relative probabilities of continuing with either a₃ or a₄ are estimated by the counts of the root causes that are still reachable via this path. For a₃, i.e., after observing o₂ and o₄, root causes r₃, r₅, and r₆ are still reachable. For a₄, i.e., after observing o₃ and o₄, root causes r₄, r₅, and r₆ are still reachable. The respective sum of counts is 5+8+16=29 and 7+8+16=31, respectively. Hence, the relative probabilities are estimated to be 29/60 and 31/60, respectively. Hence, for [symbol] =(a₁, a₂, a₃, a₄, a₅, a₆), after executing a₁, and not observing o₁, and after executing a₂ and not observing o₅, either a₃ can be executed with an estimated probability of 29/60 or execute a₄ can be executed with an estimated probability of 31/60. This results in the following the expected time to resolution for [symbol] , which is given by Equation 1:

$$ETR ( 𝒜 ) = \frac{10}{54} \cdot 10 + \frac{8}{54} \cdot ( 10 + 5 ) + \frac{29}{60} ( \frac{5}{54} \cdot ( 10 + 5 + 3 ) + \frac{31}{54} \cdot ( 10 + 5 + 3 + 5 ) ) + \frac{31}{60} ( \frac{7}{54} \cdot ( 10 + 5 + 20 ) + \frac{29}{54} \cdot ( 10 + 5 + 20 + 5 ) ) \approx 24 \text{.70} \qquad ( 1 )$$

assuming that perform a₆ does not have to explicitly be performed whenever r₆ remains the only possible root cause.

For [symbol] ′=(a₂, a₆, a₅, a₁, a₃, a₄) after executing a₂ and not observing o₅, executing a₆ and not observing o₁₃, executing a₅ and not observing o₁₁, a₁ can be executed, after which o₁ is observed with an estimated probability 10/22, o₂ is observed with probability 5/22 or o₃ is observed with probability 7/22. Whatever the observation, however, in each case there will be only one remaining root cause, such that a₃ nor a₄ need to be executed explicitly. Hence, for [symbol] ′=(a₂, a₆, a₅, a₁, a₃, a₄), the following is obtained according to Equation 2:

$$ETR ( {𝒜}^{′} ) = \frac{8}{54} \cdot 5 + \frac{16}{54} \cdot ( 5 + 5 ) + \frac{8}{54} \cdot ( 5 + 5 + 5 ) + \frac{22}{54} \cdot ( 5 + 5 + 5 + 10 ) \approx 16.11 \qquad ( 2 )$$

assuming that a₃ or a₄ do not explicitly have to be performed whenever there remains only one possible root cause.

For [symbol] ″=(a₁, a₂, a₆, a₅, a₃, a₄), the following is shown in Equation (3):

$$ETR ( {𝒜}^{′′} ) = \frac{10}{54} \cdot 10 + \frac{8}{54} \cdot ( 10 + 5 ) + \frac{16}{54} \cdot ( 10 + 5 + 5 ) + \frac{20}{54} \cdot ( 10 + 5 + 5 + 5 ) \approx 19.26 \qquad ( 3 )$$

assuming that after executing a₅ and observing either o₁₀ or o₁₁, there is only one possible root cause that remains. In that case the root cause is either r₅, r₃, or r₄. From observing 0₁₁, r₅ can be concluded to be the root cause; from observing o₁₀ and an earlier observation of o₂, r₃ can be concluded to be the root cause, from observing o₁₀ and an earlier observation of o₃, r₄ can be concluded to be the root cause.

For a given ordering [symbol] =(a₁, a₂, . . . , aₘ), not every service action aᵢ can or needs to be performed. It can be the case that aᵢ needs to be skipped, as the node where aᵢ starts can no longer be reached, given the outcomes that have already be observed. In addition, it can be the case that all service actions in suffix (aᵢ, aᵢ₊₁, . . . , aₘ) can be skipped since there is only one remaining possible root cause.

One can simply determine the expected time to resolution for each possible ordering and select the one that produces the shortest expected time to resolution. In that case, the service action a that is placed first in this given ordering is executed. After performing a and observing a corresponding outcome o and after concluding that the root cause is not yet determined, the data is updated, since potentially some parts of the fault-finding tree are no longer reachable after observing outcome o. In that case, the procedure is repeated to determine which service action should be executed next.

The service actions that are executed in this way need not form a simple path from root node to the node where the root cause is identified. The optimal ordering may involve executing service actions in different subtrees alternatingly to obtain the smallest expected time to resolution.

The methods 200, 300 include transforming a set C={c₁, c₂, . . . , c_{N}} of sequences of service actions and observations (where each sequence is related to a historical service case) to a sensible fault-finding tree 130. With each sequence cᵢ there is a corresponding root cause r(cᵢ). The fault-finding tree 130 (also referred to as 7) is generated iteratively, where in each step at most one edge is added to the fault-finding tree 130, starting with the situation that initially the fault-finding tree 130 only consists of a root node n*. The fault-finding tree 130 is a rooted directed tree, where edges 134 are directed from the root node towards the leaf nodes in the tree.

In addition, the fault-finding tree 130 is a valid resolution subtree. As used herein, the term “valid resolution subtree” refers to a subtree T′=(N′, E′) of a fault-finding tree T=(N, E), with N′⊆N and E′⊆E, is a valid resolution subtree of T with root cause r if and only if (1) for each outcome node n∈Nₒ at most one outcome edge is in E′ (such that all other outcome edges starting at n are disabled) and (2) there is exactly one path from root node to a root cause node with associated root cause r in fault-finding tree T where disabled outcome edges and subsequent subtrees are removed.

As used herein, the term “sequentialization of a subtree” refers to a sequence c=(c₁, c₂, . . . , c_{q}) with cᵢ∈A∪O is a sequentialization of a subtree T′=(N′, E′) with E′⊆A∪O if and only if there is an one-to-one mapping m from {1, 2, . . . , q} to E′ such that cᵢ=m(i) and such that there is no path from m(i) to m(j) whenever i>j.

As used herein, the term “containment of a sequence prefix in a tree” refers to a sequence prefix (c₁, c₂, . . . , cₖ₋₁) of sequence c is contained in a given fault-finding tree T if it is a sequentialization of some subtree T′ from T.

For valid resolution subtree T′ it is not required that for each outcome node n∈Nₒ exactly one outcome edge is in E′. For some outcome nodes, none of the outgoing outcome edges may be in E′, as long as there is exactly one path to a root cause node. It may be the case that given the outcomes that already have been observed and given the subtrees that are no longer reachable since the alternatives of the observed outcomes are disabled that only one possible root cause remains.

The fault-finding tree 130 is constructed for each historical case c∈C with c=(c₁, c₂, . . . , c_{q}), cᵢ∈A∪O, and associated root cause r(c). c is a sequentialization of a valid resolution subtree with root cause r(c). For convenience, short-hand notation c[1, k) is used to denote the prefix (c₁, c₂, . . . , cₖ₋₁) of sequence c. Hence, cₖ is not included in c[1, k).

An algorithm to construct the fault-finding tree 130 considers the prefixes of all sequences c∈C by increasing length, first using the prefixes of length 1 in step 1, then the prefixes of length 2 in step 2, etc. In a first step, all service actions that occur as c[1,2), i.e., the first element of a sequence c∈C, are added as label to a newly added service action edge starting at the root node, whenever it does not already appear as label of such a service action edge. Next, in step k, with k=2, 3, . . . , the algorithm operates, for a given prefix c[1, k+1)=(c₁, c₂, . . . , cₖ₋₁, cₖ), first determining whether or not c[1, k+1) is already contained in T. If so, then nothing needs to be done. If c[1, k+1) is not contained in T, then c[1, k) is contained in T, as it is handled in the previous iteration. Now, all nodes are determined, after which an edge with label cₖ can be added.

In one example, if cₖ∈O, then the edge with label cₖ is directly added to the node that is reached at the end of subtree c[1, k). In another example, cₖ∈A. In this case, all outgoing edges of a node need to be of the same type, i.e., either service action edges or outcome edges. This reduces the possible nodes at which the new edge with label cₖ can start. To determine which node is the most suitable, for given cₖ the direct predecessor count pc(c′) is considered for each c′∈A∪O, which gives the number of times that c′ is a direct predecessor of cₖ in all sequences in C. For each node n, l(n) denotes the label of the edge that ends in node. Then, the node n is chosen for which pc(l(n)) is maximal to start edge with label cₖ. If there are multiple nodes with the same maximum direct predecessor count, then preference is given to the node that is reached at the end of subtree c[1, k), if this node is among them. Otherwise, one node is randomly chosen.

Furthermore, if the end of a sequence c is reached at step k, i.e., if sequence c has exactly k elements, then the corresponding root cause r(c) needs to be added to a node with corresponding count 1. If this root cause is already available as label of one (or more) nodes, then the count of one of these nodes only is increased. If r(c) does not already occur as root cause label, then it is added to the node that is last reached with sequence c. Otherwise, if there is exactly one root cause node reachable in the subtree defined by c, i.e., if the subtree is a valid resolution subtree for root cause r(c), then the count of the unique root cause node is increased by one. If there are multiple nodes reachable with root cause r(c), then the one that already has the highest count is chosen to increase its count by one.

Table 1 (below) shows an example with a set of 34 historical sequences. Each of these sequences may occur one or more time. For reasons of simplicity, it can be assumed that they each appear only once. In practice, they can usually appear several times and these counts can play a role in determining the relative probability of each of the paths in the fault-finding tree. In this illustration, the building of the tree is considered, and the count associated to the root cause nodes is ignored. Furthermore, the duration of the service actions explicitly in this illustration are also ignored.

TABLE 1

| sequence | r.c. | sequence | r.c. | sequence | r.c. |
|---|---|---|---|---|---|
| (a₁, o₁) | r₁ | (a₂, o₄, a₆, o₁₃) | r₆ | (a₁, o₂, a₂, o₅) | r₃ |
| (a₁, o₂, a₃, o₆) | r₃ | (a₂, o₄, a₆, o₁₂, a₅, o₁₁) | r₅ | (a₁, o₃, a₂, o₅) | r₂ |
| (a₁, o₂, a₃, o₇, a₂, o₅) | r₂ | (a₂, o₄, a₅, o₁₀, a₁, o₁) | r₁ | (a₁, o₂, a₂, o₄, a₅, o₁₁) | r₅ |
| (a₁, o₂, a₃, o₇, a₂, o₄, a₅, o₁₁) | r₅ | (a₂, o₄, a₅, o₁₀, a₁, o₂, a₃, o₆) | r₃ | (a₁, o₂, a₂, o₄, a₆, o₁₃) | r₆ |
| (a₁, o₂, a₃, o₇, a₂, o₄, a₆, o₁₃) | r₆ | (a₂, o₄, a₅, o₁₀, a₁, o₃, a₄, o₉) | r₄ | (a₁, o₂, a₂, o₄, a₅, o₁₀, a₆, o₁₃) | r₆ |
| (a₁, o₃, a₄, o₉) | r₄ | (a₂, o₄, a₅, o₁₀, a₁, o₂, a₃, o₇) | r₆ | (a₁, o₂, a₂, o₄, a₅, o₁₀, a₆, o₁₂) | r₃ |
| (a₁, o₃, a₄, o₈, a₂, o₅) | r₂ | (a₂, o₄, a₅, o₁₀, a₁, o₃, a₄, o₈) | r₆ | (a₁, o₂, a₂, o₄, a₆, o₁₂, a₅, o₁₁) | r₅ |
| (a₁, o₃, a₄, o₈, a₂, o₄, a₅, o₁₁) | r₅ | (a₂, o₄, a₆, o₁₂, a₁, o₁) | r₁ | (a₁, o₂, a₂, o₄, a₆, o₁₂, a₅, o₁₀) | r₃ |
| (a₁, o₃, a₄, o₈, a₂, o₄, a₆, o₁₃) | r₆ | (a₂, o₄, a₆, o₁₂, a₁, o₂, a₃, o₆) | r₃ | (a₂, o₄, a₁, o₁) | r₁ |
| (a₂, o₅) | r₂ | (a₂, o₄, a₆, o₁₂, a₁, o₃, a₄, o₉) | r₄ | (a₂, o₄, a₁, o₂, a₃, o₆) | r₃ |
| (a₂, o₄, a₅, o₁₁) | r₅ | (a₂, o₄, a₆, o₁₂, a₁, o₂, a₃, o₇) | r₅ | | |
| (a₂, o₄, a₅, o₁₀, a₆, o₁₃) | r₆ | (a₂, o₄, a₆, o₁₂, a₁, o₃, a₄, o₈) | r₅ | | |

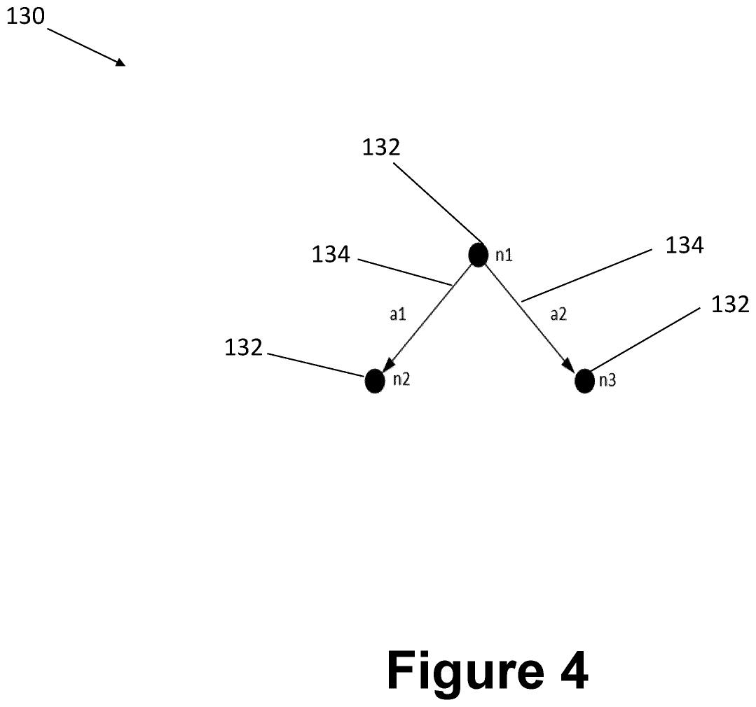

FIGS. 4-9 show examples of the generation of the fault-finding tree 130. In a first step, shown in FIGS. 4, a₁ and a₂ are added as labels to edges 134 that start at the root node 132, since these are the only service actions that appear as first service action in a sequence c.

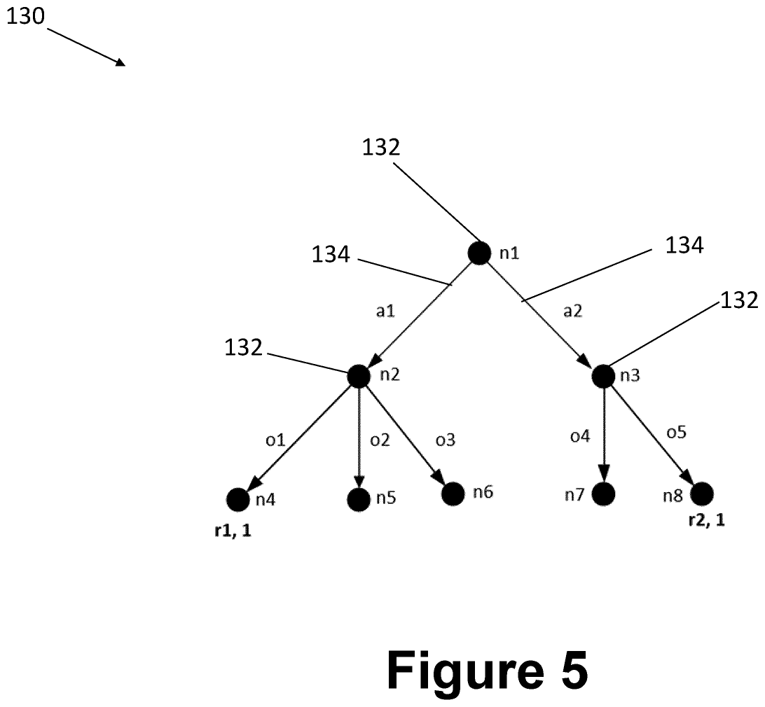

In a second step, shown in FIG. 5, a₁ is followed by o₁, o₂ and o₃ and a₂ is followed by o₄ and o₅ are shown as outcomes. Furthermore, as two sequences only contain two elements, the nodes 132 are labeled that are reached last with these sequences with their respective root causes.

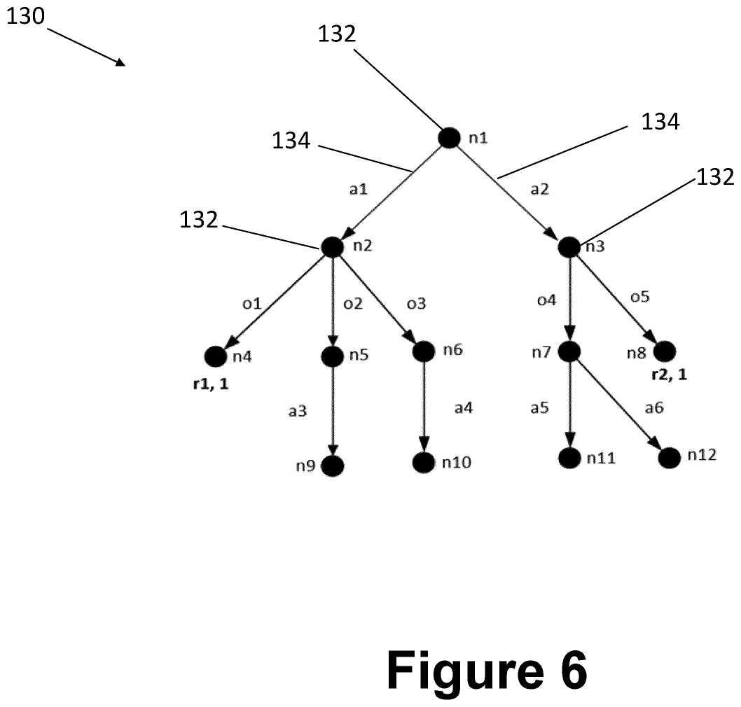

In a third step, shown in FIG. 6, 02 is followed by a₃, o₃ is followed by a₄, and that o₄ is followed by either a₅ or a₆. In addition, o₂ and o₃ are followed by a₂ and that o₄ is followed by a₁. However, prefixes (a₁, o₂, a₂), (a₁, o₃, a₂), and (a₂, o₄, a₁) are already contained as such in the current partial tree shown above. Consequently, these prefixes do not lead to extending the partial tree. Furthermore, there are no sequences of length 3, so that the root cause labelling need not be adjusted.

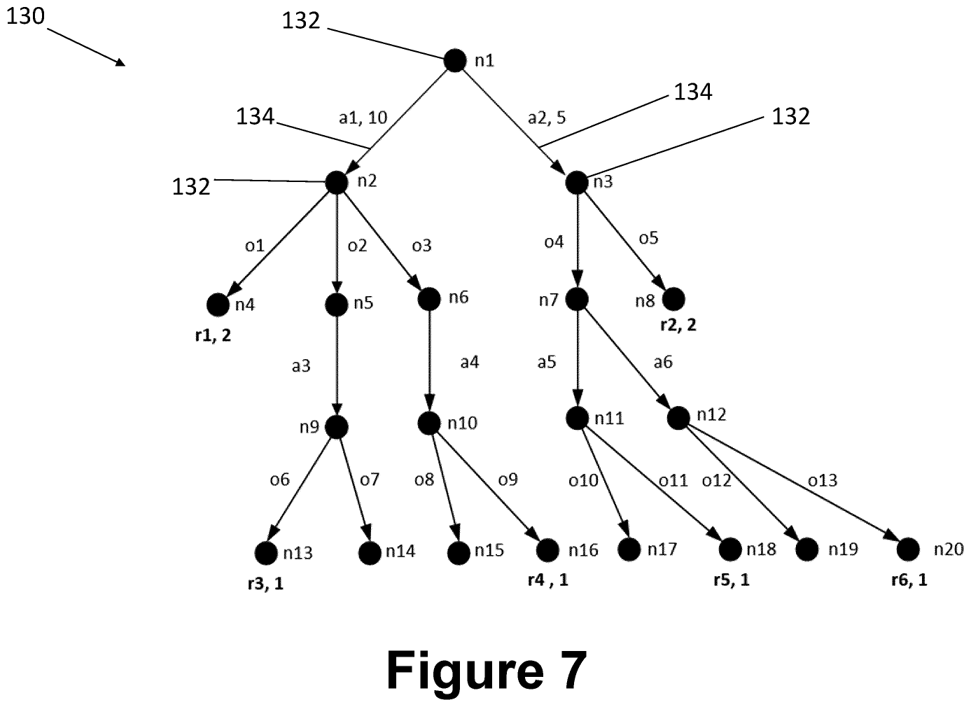

In a fourth step, shown in FIG. 7, prefixes having a length of 4 are shown. This leads to additional edges and three new root causes. The sequences (a₁, o₂, a₂, o₅), (a₁, p₃, a₂, o₅), (a₁, o₂, a₂, o₄) are already contained in the previous partial tree, so they do not lead to additional edges. However, their associated root causes lead to increasing the count of r₁ by 1 and the count of r₂ by 1. Since all prefixes of length 5 are already contained in the partial tree above, and since on sequences have a length of 5, nothing changes during the fifth step.

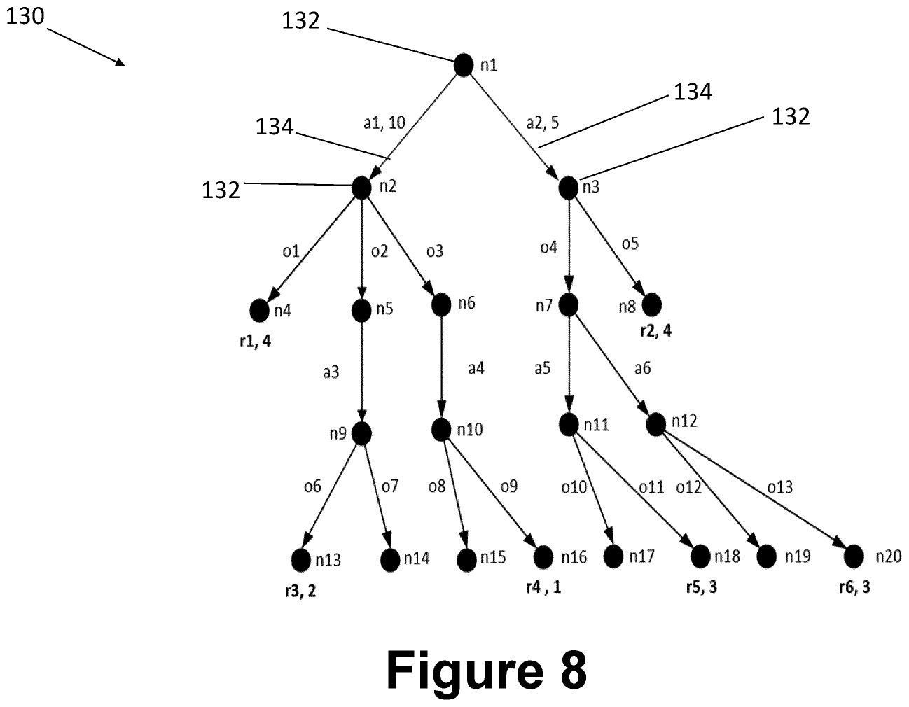

In a sixth step, shown in FIG. 8, prefixes having a length of 6 are shown. All prefixes are already contained in the tree. As there are 9 sequences of length 6, they lead to increasing the count of root cause nodes. In a seventh step, all prefixes having a length of 7 are already contained in the above tree and that there are not sequences of length 7. Thus, nothing changes during the seventh step.

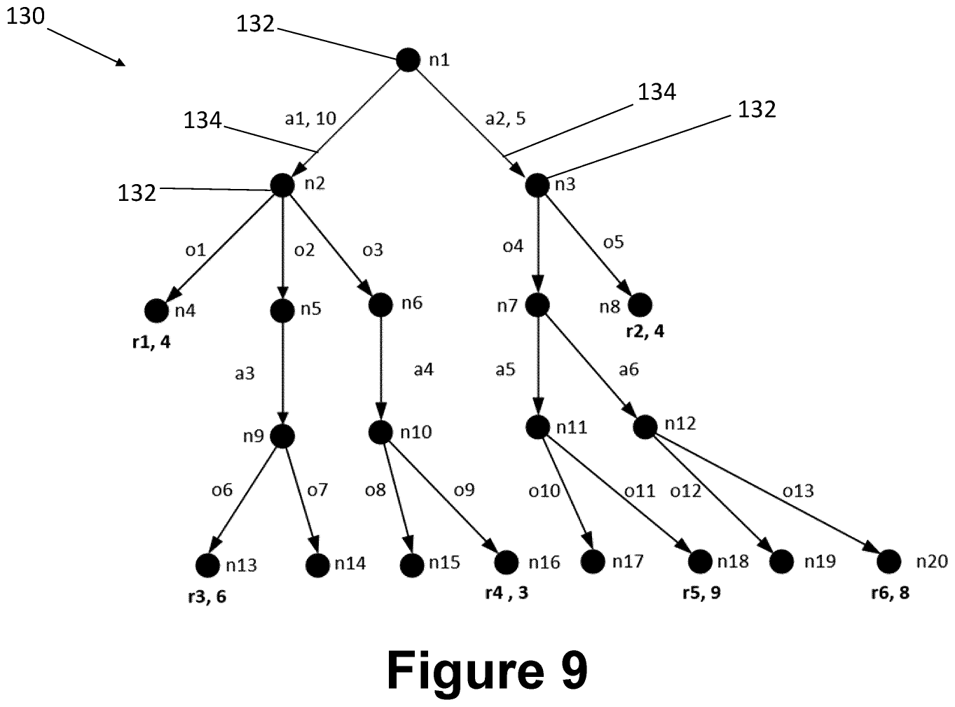

In an eight step, shown in FIG. 9, all prefixes of length 8 are already contained in the above tree. There are however 17 sequences of length 8, that lead to increase of the root cause counts. The count of a root cause node may be increased even if the node is not reached by the subtree related to the sequence. For example, sequence (a₂, o₄, a₅, o₁₀, a₁, o₂, a₃, o₇) has associated root cause r₆, while a₆ and o₁₃ are not in the sequence. However, since n₂₀ is the only root cause node that can still be reached from the subtree that is made from the sequence, it can be assumed that the count of n₂₀ can be increased.

The resulting fault-finding tree 130 is generally more compact than would be obtained using alternative algorithms to construct a fault-finding tree. A straightforward alternative is to construct a tree T′ for which each sequence c of a historical case is a path in T′. This generally leads to different nodes having the same associated root cause. Furthermore, this generally leads to less effective pruning of the fault-finding tree after observing some outcomes. More root causes still remain reachable, generally resulting in longer expected times to resolution. Apart from having the benefit of an automated construction of a fault-finding tree, this is a technical advantage of the methods 200, 300.

As used herein, the term “service action” can refer to performing some test, calibrating a subsystem, lubricating, or cleaning some part(s), et cetera. It may also involve the replacement of a part and subsequent test whether or not this solved the issue. Note that the duration of replacing a part will greatly depend on whether or not the FSE currently has a spare example of this part. If not, then replacing might cost one or more days to order and deliver the spare part. In that case, the duration d(a) of this service action a can be increased accordingly. Hence, by taking into account the immediate availability of spare parts, the duration of service actions that relate to replacing a part can be dynamically adapted, such that the algorithm will first propose other alternative service actions that may be less likely, but require less time.

As used herein, the term “outcome” can refer to the result of a single measurement or the result of a set of related measurements. Low-level measurements may have already been translated to high-level outcomes, such that the number of outcomes that can be observed after the execution of some service action is usually quite small (e.g., 2 or 3), typically yes or no, or low, medium or high. Translating low-level measurement results to these few higher-level outcomes is considered to known and already automated.

As used herein, the term “root cause” may not always be known for a historical case. Nevertheless, the solution that was used to resolve the issue can be known. In that case, this solution can be used as a proxy for the actual root cause. For example, it can be that case that rebooting the system may make the system work properly again. If this happens rarely, then rebooting can be considered as a proxy for the root cause, which may resolve the issue quickly. However, it may be desirable to also look at other historical cases, where the true root cause is found to resolve the issue in a more permanent manner.

Finding a root cause is not restricted to following one path in the fault-finding tree 130, as a leaf node may be reached that is not associated with a root cause. In that case, another service action starting at any of the service action nodes that were already reached can be chosen next. Furthermore, even if no leaf node is reached, it may be more beneficial to continue the search for the root cause first in another subtree of the fault-finding tree, than continuing at the current subtree, as a number of parts of the current subtree may no longer be reachable, which makes it more likely that the root cause will be found in another part of the fault-finding tree. At each step in the fault-finding process, the probability of a root cause r is assumed to be given by the sum of the counts (i.e., the number of associated historical cases) that are associated with the nodes that are labelled with the given root cause r and are still reachable from the set of current nodes, where the sum of the counts is divided by the sum of the counts of all nodes that are still reachable to obtain the estimate of the probability of the given root cause. Observing an outcome results in disabling the edges of the alternative outcomes (i.e., the edges that start at the same node but have a different associated outcome). Outcome edges starting at the same outcome node are assumed to be mutually exclusive. In this way, each observation of an outcome disables the edges of the alternative edges making other nodes no longer reachable and consequently changing the probabilities. By taking into account the changed probabilities, the best next step may involve switching to another part of the fault-finding tree to explicitly make use of these changing probabilities.

The fault-finding tree 130 can be constructed and updated from the maintenance service data that is captured for the whole installed base of machines of a certain type. In this way, the experience of many field service engineers is combined and the estimate for each of the paths in a fault-finding tree can be computed based on the historical data of previous service actions.

In addition, the visualization 142 of the fault-finding tree 130 on the service device 102 allows for further inspection by experienced FSEs or subject matter experts. They may remove additional assumed precedencies that could not automatically be removed in case no examples were shown in each of the collection of historical cases. For example, if in each historical case, a service action a is preceeding service action a′, then the algorithm would enforce this precedence, as it has not seen any exceptions on this rule. However, a FSE could know that service action a′ could also have been executed without first execution a. In that case a′ can generally be move to a higher level of the fault-finding tree 130, allowing it to be executed faster, whenever the probabilities would indicate that this would make sense. Furthermore, a FSE could adapt the fault-finding tree 130 on the basis of additional information that cannot yet be extracted from the set of historical cases, as it is based on a recent finding.

Visualizing the fault-finding tree 130 for the maintenance of a medical device would have additional benefits, since it provides evidence that troubleshooting for such medical devices follows a well-defined and accountable procedure.

The illustrative examples of constructing and using a fault-finding tree as disclosed herein are described in the context of assisting a FSE in diagnosing a problem with a medical imaging device. However, it will be appreciated that the disclosed approaches for constructing and using a fault-finding tree can be more generally employed in conjunction with any type of complex system diagnosis problem, such as diagnosing problems with commercial aircraft, diagnosing problems with an automobile, diagnosing problems with heavy construction machines, et cetera.

A non-transitory storage medium includes any medium for storing or transmitting information in a form readable by a machine (e.g., a computer). For instance, a machine-readable medium includes read only memory (“ROM”), solid state drive (SSD), flash memory, or other electronic storage medium; a hard disk drive, RAID array, or other magnetic disk storage media; an optical disk or other optical storage media; or so forth.

The methods illustrated throughout the specification, may be implemented as instructions stored on a non-transitory storage medium and read and executed by a computer or other electronic processor.

The disclosure has been described with reference to the preferred embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

1. A non-transitory computer readable medium storing:
a fault finding tree comprising nodes and edges, wherein the nodes include terminal nodes labeled with root causes or solutions and occurrence rates for the root causes or solutions and the edges include action edges labeled with actions and time-to-complete values for the actions; and
instructions readable and executable by at least one electronic processor to perform an iterative method for recommending actions for a fault-finding task using the fault finding tree wherein an iteration of the iterative method has an associated set of reachable action edges and reachable terminal nodes and comprises:
computing expected times to resolve the fault-finding task for different sequences of the reachable action edges using the time-to-complete values of actions associated with the reachable action edges and the occurrence rates for the reachable terminal nodes;
determining at least one recommended next action from the actions labeled to the reachable action edges based on the computed expected times;
displaying the at least one recommended next action;
receiving an outcome observation for an action performed by a user; and
determining a set of reachable action edges and reachable terminal nodes for a next iteration of the iterative method based on the received outcome observation.

2. The non-transitory computer readable medium of claim 1, wherein the iteration of the iterative method further comprises:
normalizing the occurrence rates of the root causes or solutions of the reachable terminal nodes to generate probabilities of the root causes or solutions of the reachable terminal nodes.

3. The non-transitory computer readable medium of claim 1, wherein the iteration of the iterative method further comprises:
receiving information relating to a reachable action edge;
updating the time-to-complete value labeling the action edge based on the received information; and
re-computing the expectation times using the updated time-to-complete value.

4. The non-transitory computer readable medium of claim 1, wherein the actions of the fault-finding tree comprise medical imaging device servicing actions, the root causes or solutions comprise root causes of or solutions to medical imaging device malfunctions, and the non-transitory computer readable medium further stores user interfacing instructions readable and executable by the at least one electronic processor to provide at least:
a log entry user interface for logging medical imaging device servicing,
a parts ordering user interface for ordering parts for medical imaging devices, and
a recommender user interface via which the iteration of the iterative method displays the at least one recommended next action and receives the outcome observation for the action performed by a user.

5. The non-transitory computer readable medium of claim 1, wherein the non-transitory computer readable medium further stores machine learning (ML) instructions readable and executable by the at least one electronic processor to generate the fault-finding tree by iteratively updating the fault-finding tree with each historical fault-finding sequence of a collection of historical fault-finding sequences.

6. The non-transitory computer readable medium of claim 5, wherein the iteratively updating of the fault-finding tree with each historical fault-finding sequence includes:
adding additional nodes or branches for a sequence not already in the fault-finding tree.

7. The non-transitory computer readable medium of claim 1, wherein the at least one recommended next action comprises a ranked list of recommended next actions.

8. A non-transitory computer readable medium storing instructions executable by at least one electronic processor to perform a method of generating a recommendation engine for recommending actions during performance of a fault-finding task, the method comprising:
converting a collection of historical fault-finding process sequences into a fault-finding tree having nodes, action edges and outcome edges connecting the nodes, wherein the action edges are labeled with actions of the historical fault-finding process sequences and the outcome edges are labeled with outcomes of the historical fault-finding process sequences, the nodes including terminal nodes labeled with root causes or solutions identified by the historical fault-finding process sequences; and
providing a visualization of the fault-finding tree on a user interface (UI) on a service device operable by a field service engineer (FSE).

9. The non-transitory computer readable medium of claim 8, wherein the converting is performed by adding each historical fault-finding sequence to the fault-finding tree in succession, with each historical fault-finding sequence being added to the fault-finding tree by operations including:
for each action of the historical fault-finding sequence that is not in the fault-finding tree, adding an action edge labeled with the action;
for each outcome of the historical fault-finding sequence that is not in the fault-finding tree, adding an outcome edge labeled with the outcome; and
either:
(i) if the fault-finding tree does not include a terminal node labeled with the root cause or solution identified by the historical fault-finding process sequence then adding a terminal node labeled with the root cause or solution identified by the historical fault-finding process sequence and labeling the added terminal node with an occurrence rate of 1; or
(ii) if the fault-finding tree does include a terminal node labeled with the root cause or solution identified by the historical fault-finding process sequence then incrementing the occurrence rate of the terminal node labeled with the root cause or solution identified by the historical fault-finding process sequence.

10. The non-transitory computer readable medium of claim 8, wherein the historical fault-finding sequences are historical fault-finding sequences performed by service engineers servicing medical imaging devices.

11. The non-transitory computer readable medium of claim 8, wherein the action edges are further labeled with time-to-completion values for the actions, and the method further includes:
computing an expected time to reach a root cause or solution in a current fault-finding process of an associated medical imaging device being serviced by a service engineer using the fault-finding tree including the time-to-completion values; and
wherein the visualization provided on the UI includes display of the computed expected times for the action edges.

12. The non-transitory computer readable medium of claim 11, wherein the computing of the expected time includes:
computing the expected time using the time-to-complete labels of the action edges and the probabilities of the root causes or solutions.

13. The non-transitory computer readable medium of claim 8, wherein the method further includes updating the visualization by:
receiving, via one or more inputs from the FSE, a selection of an action represented by at least one terminal node;
recording an outcome of the selected action.

14. The non-transitory computer readable medium of claim 13, wherein the updating includes:
performing a natural language processing (NLP) process on text entered by the FSE to the service device, the text being indicative of the selection of the at least one terminal node.

15. The non-transitory computer readable medium of claim 13, wherein the updating includes:
extracting one or more selections of actions to be performed by the FSE from a service log of the associated medical imaging device.

16. The non-transitory computer readable medium of claim 8, wherein the providing of the visualization includes:
displaying, on the UI, an entirety of the fault-finding tree as the visualization showing default expected time-to-complete labels for the action edges and raw counts for the root causes.

17. The non-transitory computer readable medium of claim 8, wherein the providing of the visualization includes:
displaying, on the UI, a portion of the fault-finding tree showing only root causes with probabilities reachable as a possible root cause of the maintenance of the associated medical imaging device.

18. A service device, comprising:
a display device;
at least one user input device; and
at least one electronic processor; and
a non-transitory storage medium storing instructions readable and executable by the at least one electronic processor to perform an iterative method for recommending actions for a fault-finding task using a fault finding tree wherein an iteration of the iterative method has an associated set of reachable action edges and reachable terminal nodes and comprises:
computing expected times to resolve the fault-finding task for different sequences of the reachable action edges using the time-to-complete values of actions associated with the reachable action edges and the occurrence rates for the reachable terminal nodes;
determining at least one recommended next action from the actions labeled to the reachable action edges based on the computed expected times;
displaying the at least one recommended next action;
receiving an outcome observation for an action performed by a user; and
determining a set of reachable action edges and reachable terminal nodes for a next iteration of the iterative method based on the received outcome observation.

19. The service device of claim 18, wherein the iteration of the iterative method further comprises:
normalizing the occurrence rates of the root causes or solutions of the reachable terminal nodes to generate probabilities of the root causes or solutions of the reachable terminal nodes.

20. The service device of claim 18, wherein the iteration of the iterative method further comprises:
receiving information relating to a reachable action edge;
updating the time-to-complete value labeling the action edge based on the received information; and
re-computing the expectation times using the updated time-to-complete value.
